(19) United States
(12) Patent Application Publication
(10) Pub. No.: US 2020/0387929 A1
(43) Pub. Date: Dec. 10, 2020

(54) MOBILE DEVICE FOR DISPLAYING DIGITAL CONTENT

(71) Applicants: Yuan Zhu, Los Angeles, CA (US); Thomas Lai, Los Angeles, CA (US); Jordan Drake Lai, Los Angeles, CA (US)

(72) Inventors: Yuan Zhu, Los Angeles, CA (US); Thomas Lai, Los Angeles, CA (US); Jordan Drake Lai, Los Angeles, CA (US)

(21) Appl. No.: 15/931,156

(22) Filed: May 13, 2020

Related U.S. Application Data
(60) Provisional application No. 62/847,170, filed on May 13, 2019.

(51) Int. Cl. G06Q 30/02; G06F 3/14; G06F 16/29; A45F 3/04; G09F 21/02; G09F 9/33

(52) U.S. Cl. CPC G06Q 30/0261; G06F 3/1446; G06Q 30/0273; G06Q 30/0257; A45F 2003/003; G06F 16/29; A45F 3/04; G09F 21/026; G09F 9/33; G06Q 30/0267

(57) ABSTRACT

A mobile apparatus comprising a backpack having an inward body side and an outward non-body side, where the body side and the non-body side define an interior compartment. The backpack includes an active element coupled to an outer surface of the non-body side of the backpack, where the active element comprises a digital display. The backpack further includes a removable power supply housed in the interior compartment of the backpack, and a transmitter electrically coupled between the power supply and the active element. The transmitter is in wireless electrical communication with a remote central processing unit (CPU) for receiving and sending data files of content and images to be broadcast on the active element.

### TECHNICAL FIELD

The present disclosure generally relates to digital displays, and more specifically, to augmented digital display screens arranged on the outer surface of a wearable apparatus, and more particularly to a backpack, which employs electrical communications for connectivity.

### BACKGROUND

Backpacks, knapsacks and rucksacks (collectively referred to as “backpack”) provide a distinctiveness in mobility procuring commercial augmented display device in providing advertisement to areas which traditional methods use an electronic signage or printed advertisement cannot infiltrate, thus, creating a windfall of opportunities in advertisements, as a mobility procuring commercial augmented display device, such as a backpack, this marvelous and convenient way for transporting a digital commercial content carried by a pedestrian can overcome traditional barriers, such as, electronic billboards and illuminated signage (electronic signage) requires getting a sign variance approval by zoning board and worried about community updating it's sign code by local authorities before it can be mounted on walls or onto the ground and it carries higher risks investments due to cost in rental, service, electricity, location may not be ideal after implementing, and these are the cost incurred by the operator and owner of the signage. Unlike, traditional printed materials, brochures and flyers, or vinyl billboards and banners hung or fixated to the ground or manually distributed printed materials, its one-dimensional form of advertisement, whereas, a video commercial would amplify and convey the advertising message more effectively and efficiently due to visual and sounds convergence provides a more compelling ad. Due to its commercial design and applications, the backpacks offer accessibilities to enter more spaces whenever distributing printed materials may be prohibited, making backpacks easier to enter these restricted spaces as a pedestrian. These opportunities provide an owner of a mobility procuring commercial augmented display device earning income through Aladdin Ring App, it provides ads for hire to help supplement men and women incomes that live, work and leisurely travel these destinations and routes each day where advertisers seek opportunities for mass exposure and reached the most relevant people to view their ads because of its great location, thus, providing a very distinctive “utility patent” in the advertising category using a backpack.

Entertainment and amusement is another potential usage for backpacks. The digital display having MicroLEDs (microscopic light-emitting diodes) or MiniLEDs (sub-millimeter light-emitting diodes) arranged on the outer backpack surface as an augmented display screen further differentiates its technology from any other light-emitting diode (LED) screen as the image provides superior brightness, color, clarity, and color gamut provides higher resolution for viewing experiences, each backpack is designed as modular that can individually connect to form a larger screen that helps enhances the entertainment or amusement experience as size of the screen no longer are limited to factory size screen for each backpack has a lock and clipped feature that allows each backpack to expand in sizes, thus, this distinctive “design” is unique and further distinguishes mobility procuring commercial augmented display device than any existing backpack by design appearance. With these new technology and designs features built-into the backpack, a new viewing experience are created as these backpacks are mobile and can easily be transported to anywhere the owner brings their backpack for entertainment or amusement viewing, furthermore, it will clearly separate itself from another backpack visually, however, each backpack will adhere to traditional functionality that are commonly known as a rucksack, knapsack and backpack.

The backpack has become a necessity of humans and dates back as far as 3300 BC with Otzi the Iceman, a mummy from the Copper Age, carried a rucksack made from animal fur for carrying personal essential for his survival during his travels, the first knapsack was developed by Colonel Henry Miriam of the Seventh Infantry for the U.S. military and granted a patent in 1877, and by 1882, Camille Poirier improved the military bag with his Duluth Pack for the Navy, that featured a head strap that was secured by straps and buckles, however, by 1938, the first zippered backpack was created by Gerry Cunningham from Boulder, Colo., his zippered backpack inspired others to create zippered backpacks with compartments which made it possible for the load to be distributed on the back evenly, with continue development, Dick and Nena Kelty introduced the first use of aircraft-aluminum contoured frames, padded shoulder straps, waist belts, clevis-pins, and nylon pack cloth in 1952, and in 1967, the first backpack to resemble the modern day backpack was developed by Greg Lowe when he created the first internal frame backpack. The modern backpack continues to evolve, but, rucksack, knapsack and backpack all share the common functionality that our human ancestry used them for transporting everyday items that were essential to their lives. The present disclosure follows in suit with improvements, such as, waterproof material that protect the valuables inside backpack from water damage, it has a compartment for storing water sensitivity as electronics, such as, notebook or laptop computers, a modern equivalent of everyday items that are essential in modern times, in addition, its comprises functional electronics equipment that earns money for its owner to carry around while foraging to the next destinations or route in completing an advertising task. The backpack function similar to Otzi the Iceman for carrying his necessity as he travels in search of life's necessity for survival, however, his rucksack did not provide him money for traveling to popular destinations or route, whereas, money provides any article or substance used as a medium of exchange, an essential for human civilization. This modern version of the backpack has distinctive utility and design while revolutionizing human necessity for carrying personal items with an opportunity for monetizing off the use of owning a backpack in which one can purchase life's necessity for survival with money earned from performing an advertising task with their backpack.

Another quintessential of modern human beings are the desires for accessorizing one's outer appearance to complement their looks with fashionable electronic designs accessories as pagers were worn on belts clips or when earphones were attached to clothing with one earpiece inside the ear, later followed by the massive success of the smartphones and all the different leather, aluminum, metal and polyvinyl chloride (PVC) cases to cover the phone's backside.

The backpack will follow suit as the smartphone frenzy in newest design, however, unlike the smartphones, they were limited to exposure due to the small screen size, furthermore, one needs to take out the smartphone from purses, bags or from their pants or jackets and begins to use them in public, whereas, mobility procuring commercial augmented display device can be seen when worn on their shoulders and hung on their backs. Due to its large distinctive digital screen size, a plethora of screen cover designs would cover the display screen perimeter made from PVC materials to leather, aluminum, and metal for decorating displaying screen side having MicroLED or MiniLED would provide unlimited digital image and provide unlimited personal self-expression that includes original and licensed popular culture brands for the wearer of the backpack to be seen in public as they travel on foot.

### SUMMARY

An augmented linear advertisement digital display Internet network reconnaissance intelligence news gathering (collectively referred to as “Aladdin Ring”) device is described herein as a mobility procuring commercial augmented display device that appears, resemble, function, and commonly known or associated as a backpack. According to one embodiment, the present disclosure of the invention is a wearable mobility backpack with power unit and electric communication with connectivity built-into a MicoLED or MiniLED digital display screen that can be used in playing video files on the move rather than a portable backpack that can be move from place to place but not be in use, that also includes one side for body contact with the device, a non-body contact side with the device, whereas, an augmented digital display screen is built-in the backpack along with a power source, such as a rechargeable battery, it may have a charging port, and a remote control unit replaced with a downloadable App for controlling augmented digital display screen on the backpack. The side of the body with contact to the device will include at least two padded shoulder straps that can be hung on the user's shoulder with equal weights evenly distributed for the non-body contact side of the device of the augmented digital display screen for reducing the weight, otherwise, the backpack would be very heavy when transporting, as all four sides have capabilities for lock and clip for fastening one or more backpacks for expansion of the augmented digital display screen into one enormous screen.

According to another embodiment, the present disclosure of the invention is directed to a mobility procuring commercial augmented display device that includes a wearable apparatus, with a digital display screen having MicoLEDs or MiniLEDs embedded on the outer surface of a wearable backpack. This integrated electronic display screen may display content on one video display device on the screen of another device simultaneously. The device that streams or transmits the image may be a smartphone or a remote-control unit, however, both smartphone and the remote-control unit may be redeveloped as a downloadable App for the device that receives the streaming image or representing signal of the image, the digital display screen or commonly known as the backpack.

According to another embodiment, the present disclosure of the invention is directed towards the augmented digital display screen outer perimeter, the top of the screen's side, the bottom of the screen's side, the left side of the screen's side, and the right side of the screen's side. The augmented digital display screens are individual modules (collectively referred to as “backpack or module”) that can be connected to form one unison screen and play seamlessly as one video file on the digital display screen. Each screen has zippers that open and exposes the modular connections for additional modules to easily attach, thus, creating a larger digital display screen. In some implementations, the modular connectors may comprise magnets having complementary polarity. For example, the modular connector on one side of an active element may have a positive polarity (+pole) that couples to the negative pole (−pole) of a modular connector on a complementary side of an adjoining active element.

According to another embodiment, the present disclosure of the invention is directed towards the lock and clipped found on the body with contact to the device or commonly known as the back of the backpack, whereas, two padded shoulder straps that can be hung on the user's shoulders are depicted. There are four locations for the lock and clip for securing the module when connected to another module, upper top of the backpack, the bottom of the backpack, the left side of the backpack, and the right side of the backpack. These features help secure each backpack whenever a module is aligned with another module. This configuration provides endless expansion for the size of the viewing digital display screen, as the left side of a backpack may align with the right side of another backpack using the lock and clip to join two backpacks horizontally to create one larger modular digital display screen. In the same way, a bottom edge of a backpack can align with the upper top edge of another backpack using the lock and clip, joining two backpacks vertically to create one larger modular digital display screen.

According to another embodiment, the present disclosure of the invention is directed towards speakers and a camera that are fixated on the top of the backpack and adjacent to the augmented digital display screen, when video files play, sounds are projected and amplifies directly forward, whereas, the camera sits center between the speakers opening to its right and left.

According to another embodiment, the present disclosure of the invention is directed towards the bottom edge of the backpacks, where there are two opening slots on opposite sides for twisting into the backpack, creating four wheels all together for easier mobility support, whenever, the screen becomes too large, these wheels help provides support while the backpack is strapped on the pedestrian to walk and maneuver due to many backpacks being locked and clipped together to form a large digital display screen.

According to another embodiment, the present disclosure of the invention is directed towards an advertising network, commission model and e-commerce model that is a direct byproduct of the backpack effect on creating a new digital marketplace, otherwise, could not have been feasible due to the emergence of newer technology, such as, MicoLED and MiniLED. In other embodiments, the wearable backpack's owner becomes the product itself in the digital marketplace, commonly known as a user.

The disclosure of the invention in this summary is not an extensive overview of all contemplated embodiments, it should be appreciated that many other features, applications, embodiments, and/or variations of the disclosed technology will be apparent from the accompanying drawings and from the following detailed description, while multiple embodiments are disclosed, however, the drawings and detailed description are to be regarded as illustrative in nature and not restrictive.

### BRIEF DESCRIPTION OF THE DRAWINGS

This disclosure may be better understood by referring to the following figures. The components in the figures are not necessarily to scale, emphasis instead being placed upon illustrating the principles of the disclosure. In the figures, like reference numerals designate corresponding parts throughout the different views.

FIG. 1 illustrates an example of a backpack having a mobility procuring commercial augmented display device, according to one or more embodiments.

FIG. 1A illustrates an example of a remote-control unit as an active element of the backpack of FIG. 1, according to one or more embodiments.

FIG. 1B illustrates an example of a rear of a backpack having a mobility procuring commercial augmented display device, according to one or more embodiments.

FIG. 2 illustrates an example of circuit of a backpack having a mobility procuring commercial augmented display device, according to one or more embodiments.

FIG. 3 illustrates an example of a frontal view of a backpack having a mobility procuring commercial augmented display device, according to one or more embodiments.

FIG. 3A illustrates an example of a side view of a backpack having a mobility procuring commercial augmented display device, according to one or more embodiments.

FIG. 3B illustrates an example of an opening interior compartment for storage of a backpack having a mobility procuring commercial augmented display device, according to one or more embodiments.

FIG. 3C illustrates an example of wearing a backpack having a mobility procuring commercial augmented display device, according to one or more embodiments.

FIG. 4 illustrates an example of a horizontal lock and clip of a backpack having a mobility procuring commercial augmented display device, according to one or more embodiments.

FIG. 5 illustrates an example of a vertical lock and clip of a backpack having a mobility procuring commercial augmented display device, according to one or more embodiments.

FIG. 6 illustrates an example of connecting two or more modular and displaying the video file on a backpack having a mobility procuring commercial augmented display device, according to one or more embodiments.

FIG. 7 illustrates an example of two or more modular attached utilizing horizontal and vertical lock and clipped while a pedestrian displays the video file on a backpack having a mobility procuring commercial augmented display device, according to one or more embodiments.

FIG. 8 illustrates a method using their remote-control (user's smartphone) for accessing ALADDIN RING App advertising network, “EXPLORE” is for searching ads for hire for displaying the video file on a backpack having a mobility procuring commercial augmented display device, according to one or more embodiments.

FIG. 8A illustrates a method using their remote-control (user's smartphone) for accessing ALADDIN RING App advertising network, “SAVED” is when an independent contract worker agreed and accepts an ad for hire job booking in advance from an advertiser for displaying the video file on a backpack having a mobility procuring commercial augmented display device, according to one or more embodiments.

FIG. 8B illustrates a method using their remote-control (user's smartphone) for accessing ALADDIN RING App advertising network, “PAID” allows user and Aladdin Ring's members to send money using automated clearing house (ACH) payment processing within the same network of Aladdin Ring members, after completing an ad work, money can be sent to the account of the independent contract worker for displaying the video file on a backpack having a mobility procuring commercial augmented display device, according to one or more embodiments.

FIG. 8C illustrates a method using their remote-control (user's smartphone) for accessing ALADDIN RING App advertising network, “INBOX” allows user and Aladdin Ring's members to communicate with one another within the same network, such as, instructions on setting up Aladdin Ring's account or as to where the ad for hire for displaying the video file on a backpack having a mobility procuring commercial augmented display device, according to one or more embodiments.

FIG. 8D illustrates a method using their remote-control (user's smartphone) for accessing ALADDIN RING App advertising network, “PROFILE” allows a person to describe, upload their personal picture as a public figure online, etc., includes downloading the advertiser's video for displaying as a video file on a backpack having a mobility procuring commercial augmented display device, according to one or more embodiments.

FIG. 8E illustrates a method using their remote-control (user's smartphone) for accessing ALADDIN RING App advertising network, “CAMERA” allows user to take photos and videos for sending to the advertiser before, during and after completing an ad for hire job from displaying the video file on a backpack having a mobility procuring commercial augmented display device, according to one or more embodiments.

FIG. 8F illustrates a method using their remote-control (user's smartphone) for accessing ALADDIN RING App advertising network, “FILMTUBE” allows the user to access and stream live videos for displaying the video file on a backpack having a mobility procuring commercial augmented display device, according to one or more embodiments.

FIG. 8G illustrates a method using their remote-control (user's smartphone) for accessing ALADDIN RING App advertising network, “SETTINGS” allows the user to access and configure standard defaults, such as, manage storage of data for seemingly smooth playing of advertiser's message for displaying the video file on a backpack having a mobility procuring commercial augmented display device, according to one or more embodiments.

FIG. 8H illustrates a method using their remote-control (user's smartphone) for accessing ALADDIN RING App advertising network, “GAMES” allows the user to access and play online streaming video games for displaying the video file on a backpack having a mobility procuring commercial augmented display device, according to one or more embodiments.

FIG. 8I illustrates a method using their remote-control (user's smartphone) for accessing ALADDIN RING App advertising network, “UTILITIES” allows the user to access and maintenance the App for seemingly smooth operation whenever operations needs corrections, therefore, resulting in success in displaying the video file on a backpack having a mobility procuring commercial augmented display device, according to one or more embodiments.

FIG. 9 shows a method of an interface for displaying the video file on a backpack having a mobility procuring commercial augmented display device, according to one or more embodiments.

FIG. 10 illustrates an example of a flexible MicroLED or MiniLED having a mobility procuring commercial augmented display device, according to one or more embodiments.

FIG. 11 illustrates an example of the backpack and mobile device incorporating the digital display apparatus of the present disclosure.

### DETAILED DESCRIPTION

The present disclosure is a mobility procuring commercial augmented display device, comprising a wearable apparatus, such as a rucksack, knapsack, and backpack, with a digital display having MicroLEDs or MiniLEDs arranged on the outer surface of the backpack as an augmented display screen that receives and plays video files, aminated videos, digital pictures, digital graphic images, digital lightings, and digital text from a processing hardware may be observed and audio heard as part of the external appearance of a stand-alone wearable backpack or when grouped together with one or more backpacks may be locked and clipped to create a single, united and larger augmented display screen when one or more additional MicroLED or MiniLED backpacks are secure together to produce one singular image display. When disseminated, these modular display screens may be displayed at random or at specific locations at the discretion of the owner. It includes built-in camera and speakers (MP3/WMA/AAC, etc.) for sounds that can deliver full digital contents, similar to television ads or online advertisement, in a format of a commercial for advertising opportunities control wirelessly by a smartphone App (Aladdin Ring) or manual input by universal serial bus (USB) flash drive for playing paid advertising contents delivered to a specific location, time and duration of commercial destinated by the paid advertiser, commonly refer to as, strategic targeted advertisement reconnaissance (STAR), owner of the backpack will be compensated through the Aladdin Ring App after complying to United States federal banking laws know-your-customer (KYC Rule) or similar recognize government authority of the owner's banking country or territory using automated clearing house (ACH) payment processing for compliance with the banking laws. The backpack may include the following, a revolutionary user interface display screen having MicroLED or MiniLED, a removable and rechargeable battery for a power source with an electrical communication for GPS (Global Positioning System), mesh technology, mesh wireless network, video mirroring (showing the contents of one video display device on the screen of another device simultaneously), Graphics Processing Unit (GPU), graphics cards, video cards, General Packet Radio Services (GPRS), Wi-Fi tethering, 5G chipset, 5G NR, mmWave, sub-6 GHz, 5G/4G spectrum sharing, FDD, TDD, SA (standalone), NSA (non-standalone), 800 MHz bandwidth, 2×2 MIMO, 200 MHz bandwidth, 4×4 MIMO, 100 MHz envelope tracking, adaptive antenna tuning, cellular technology as WCDMA (DB-DC-HSDPA, DC-HSUPA), TD-SCDMA, CDMA 1×, EV-DO, GSM/EDGE, 8 GB memory, 802.11b/g/n (WiFi), and Bluetooth 4.0 enable for online and offline data gathering. The backpack fabric may comprise made waterproof ripstop nylons designs and serve primarily as a water repellent against water spills, mild, and exposure to moist environments.

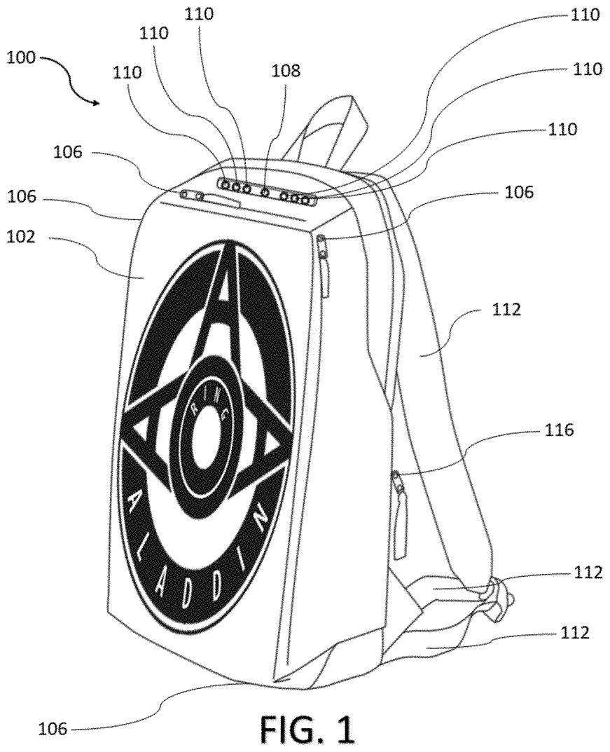

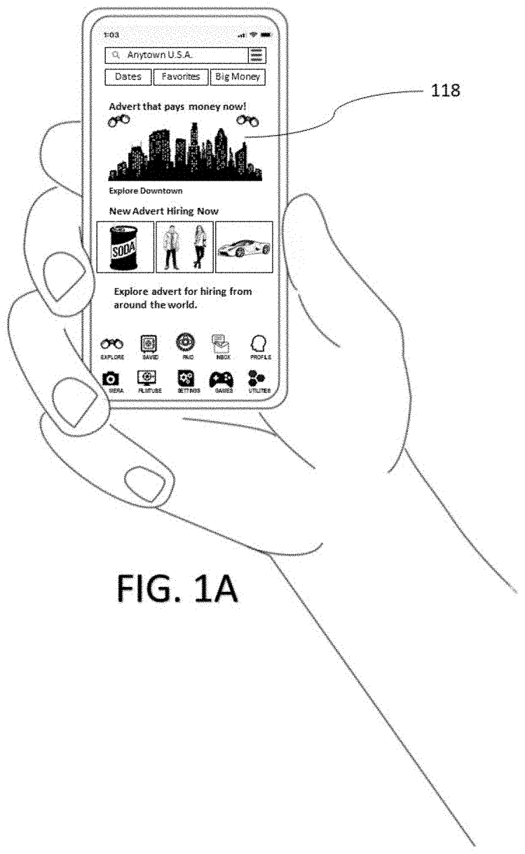

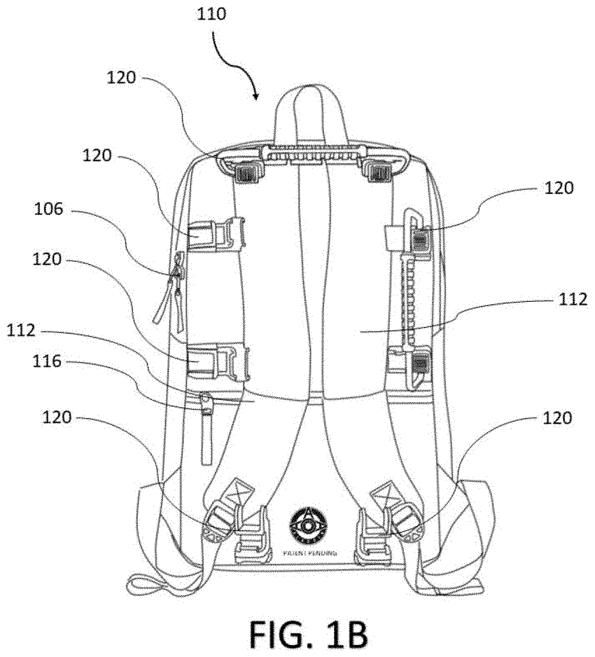

FIGS. 1-10 illustrate examples of various implementations of a mobile apparatus for displaying digital content. As described herein, the apparatus may include a backpack incorporating a MicoLED or MiniLED digital display for broadcasting content and images.

FIG. 1 illustrates an example of a backpack 100 having a digital display apparatus of the present disclosure. The backpack 100 may include an augmented display device having one or more MicoLEDs or MiniLEDs 102 comprising a screen for playing video files. These MicroLEDs or MiniLEDs 102 comprise modular units surrounded on all four perimeters with zippers 106 that can be opened to connect with another modular unit to form a larger viewing screen. The top of the backpack 100 and adjacent to modular zipper 106 opening may include a camera 108 for pictures and video recording, within the same design are speakers 110, and may have a microphone for recording as well as playing sounds. The backpack 100 may have one or more carrying straps 112 and additional zippers 116 that has one or more storage compartments for carrying one's valuable. The backpack 100 may have an internal frame configured into the design for support for MicroLED or MiniLED 102, including an integrated circuit board, power supply, such as, rechargeable battery, may have a connecting power source for connecting more modular and cables for MicroLED or MiniLED 102 for continuous display for screen to expand and plays static and dynamic image, such as, video file, within the internal frame, may have compartments that allows the backpack to expand in size for additional storage while providing a structural foundation for the MicoLED or MiniLED 102 facade, and in general, the backpack 100 may be constructed of ripstop nylon, canvas, leather, nylon, neoprene, or other materials that provide functionality, such as, water repellent material or help create a perceived aesthetic design for attractiveness for consumer purchase consumption.

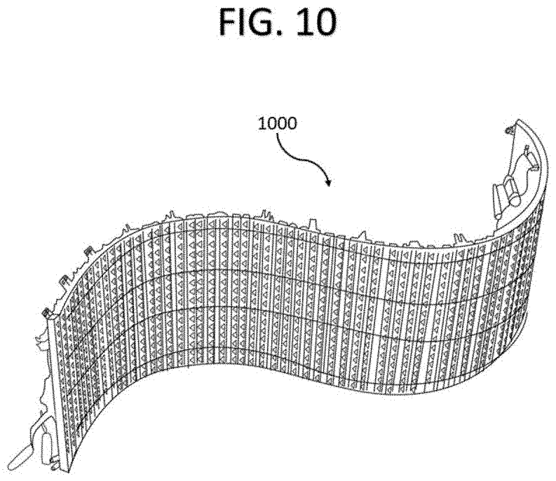

The active element 102 may be configured to display high-resolution video files, whereas current light-emitting diode (LED) devices are typically limited to text, graphics, and images due to the poor resolution quality of displayed video files. Thus, providing MicoLED or MiniLED as means for displaying high-resolution audio-visual content, similar to motion picture films, when formatted for backpack 100 display screens for implementing mobility procuring commercial augmented display device for successfully delivering high-resolution video clarity and quality for the eyes to visibly be seen when delivering dynamic rather than static images that the advertiser may elect display one or more colors, designs, images, series of images, video files, and/or other elements. The backpack 100 non-body contact side may have full active element 102 to be positioned and incorporated onto the backpack 100 non-body contact side and the entire outer surface of the backpack, for example, as shown on FIG. 1, the active element 102 covers the entire non-body contact side, this feature, enable the screen the abilities to connect as modular and embody as one larger screen display a seemingly smooth image without partition line of interruption creating a distinguish utility and design. The active element may have a user interface MicroLED or MiniLED screen, thus, creating another utility that distinguishes our backpack 100 from any other backpack with touch screen technology. The active element 102 may generally have any suitable shape, such as, round backpack, rectangle backpack, square backpack, hexagon backpack, or any other shapes, as they are all modular and can be connected to form a larger display screen, further, distinguish design and utility from other backpacks. The display screen 102 may have flexible MicroLED or MiniLED can bend, wrap, drape, and fold to conform to even the most unusual shape and size as shown on FIG. 10.

FIG. 1A illustrates an example of a mobile device 118 comprising a smartphone utilizing a mobile application, in electronic communication with an active element of backpack 100 having a mobility procuring commercial augmented display device of the present disclosure. In this example, the mobile application comprises the ALADDIN RING App. The ALADDIN RING App may be downloaded onto a smartphone, after setting up an account using telephone number and login into ALADDIN RING App for verifying backpack 100 credentials, both smartphone and backpack 100 are known as sending and receiving, however, both can work interchangeable, but only one can take priority, usually the owner's smartphone or remote-control 118.

FIG. 1B illustrates an example of a rear of a backpack 110 having a mobility procuring commercial augmented display device with lock and clipped 120 for securing two or more modular of the present disclosure. The rear of the backpack 110 may have polyvinyl chloride (PVC), aluminum, brass, metal, or other materials in construction that provides a functionality feature, such as, a mechanism that locks two or more backpack 100 together. Lock and clip 120 functionality are unique design and provides a true utility in securing two or more backpack 100, thus, creating a distinguishing physical appearance than any backpack with its securing mechanism provides a necessary utility for a larger viewing display screen. Another functionality, a compartment opening by a zipper 116 that allows additional storage of valuables and one or more straps 112 for carrying the mobility procuring commercial augmented display device is shown.

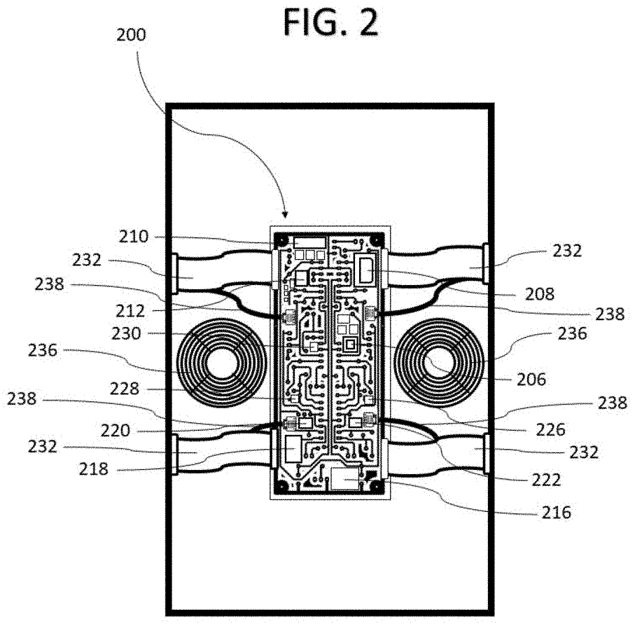

Turning to FIG. 2, an example of a circuit board 200 built-into a backpack 100 having a digital display apparatus of the present disclosure is shown. In some embodiments, the circuit board 200 may have a modem chip 206, a power supply 208, power management integrated circuit (PMIC) 210, central processing unit (CPU) 212, random access memory (RAM) 216, flash memory card 218, graphic processing unit (GPU) 220, general packet radio services (GPRS) 222, video card 226, graphic card 228, sending and receiving card 230, computer ribbon connector 232, computer ventilation fan 236, ASDL cable 238, or other circuit components and software that provides functionality, such as, device driver that allows an operating system to communicate with a hardware device.

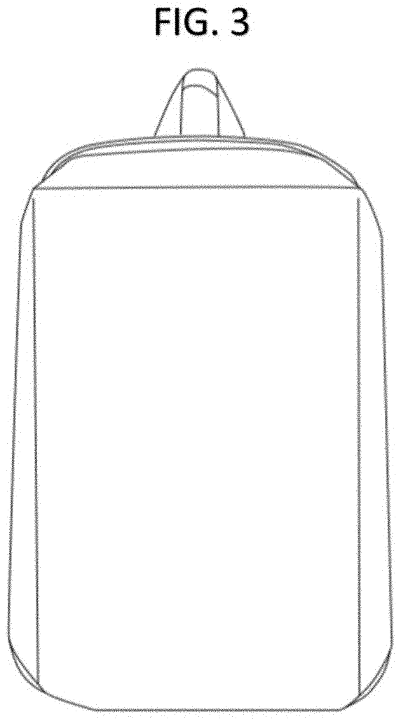

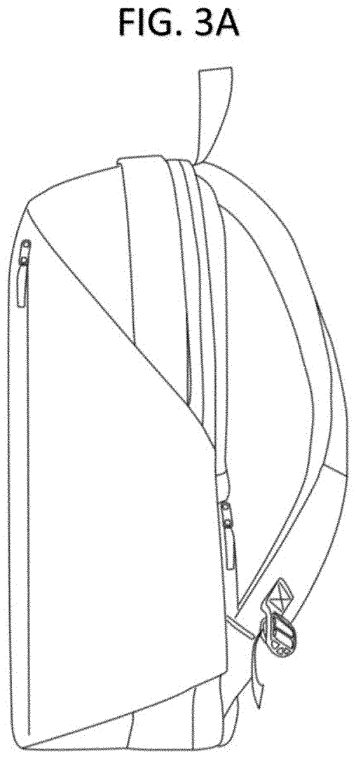

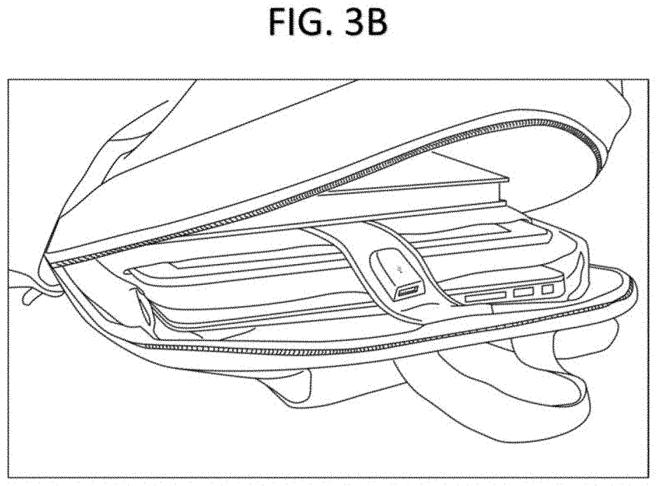

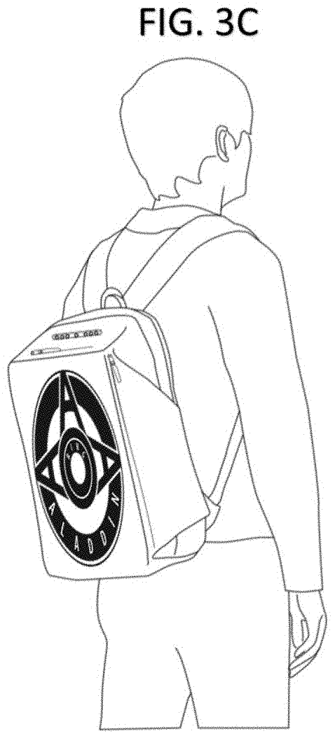

FIG. 3 illustrates an example of frontal of backpack 100 and visual appearance of a frontal illustration of display screen 102 while turned off.

FIG. 3A illustrates an example of sideview of backpack 100.

FIG. 3B illustrates an example of the top of backpack 100 opening showing a universal serial bus (USB), notebook computer, and compartments for storage of personal valuables.

FIG. 3C illustrates an example of a pedestrian carrying backpack 100 with digital screen 102 displaying the Aladdin Ring emblem, the independent contract worker is a strategic targeted advertisement reconnaissance (STAR).

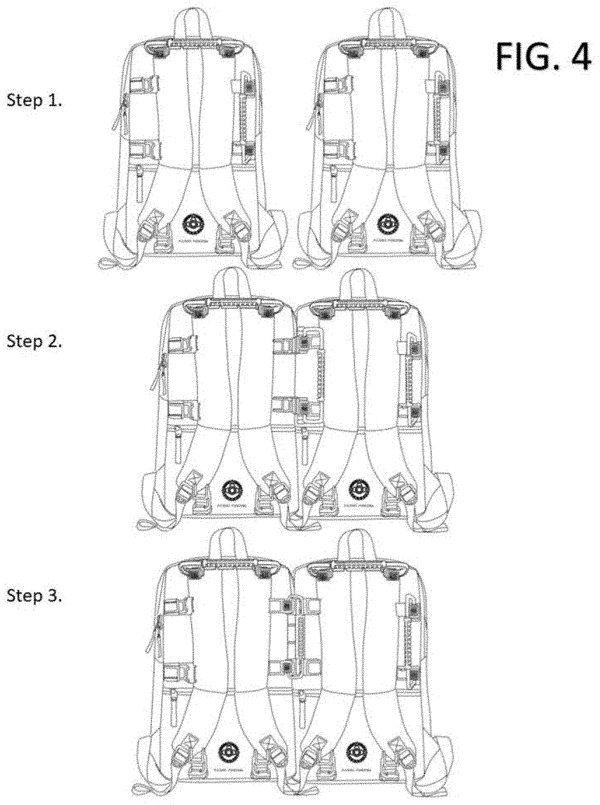

FIG. 4 illustrates an example of the rear of backpack 110 showing two modular units connected with a lock and clip 120 with the last illustration on the bottom, Step 3 displaying a horizontal lock and clip rear backpack 110.

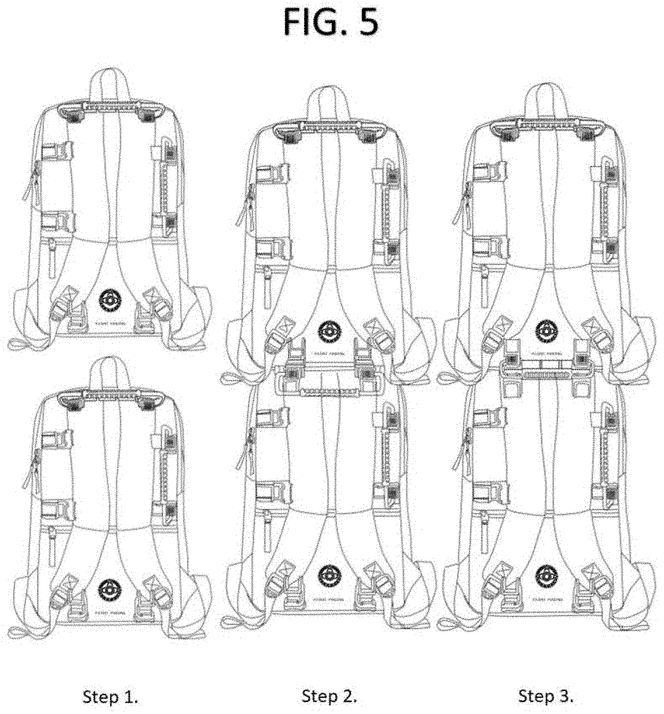

FIG. 5 illustrates an example of the rear of backpack 110 showing two modular units connected with a lock and clip 120 with the last illustration on the right-hand side of the page, Step 3 displaying a vertical lock and clip rear backpack 110.

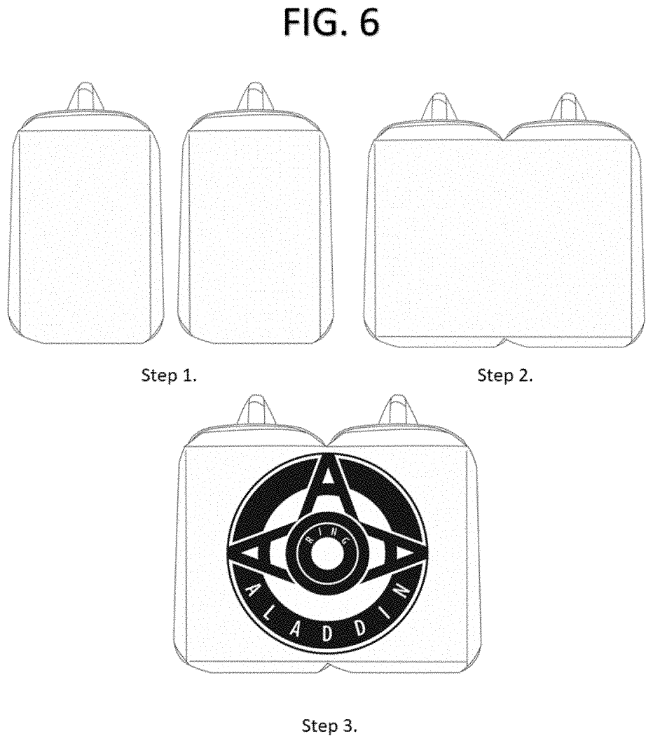

FIG. 6 illustrates an example of backpack 100, as shown, two modular units are connected with the last illustration of Step 3 displaying a horizontal lock and clip backpack 100 displaying an Aladdin Ring emblem on display screen 102.

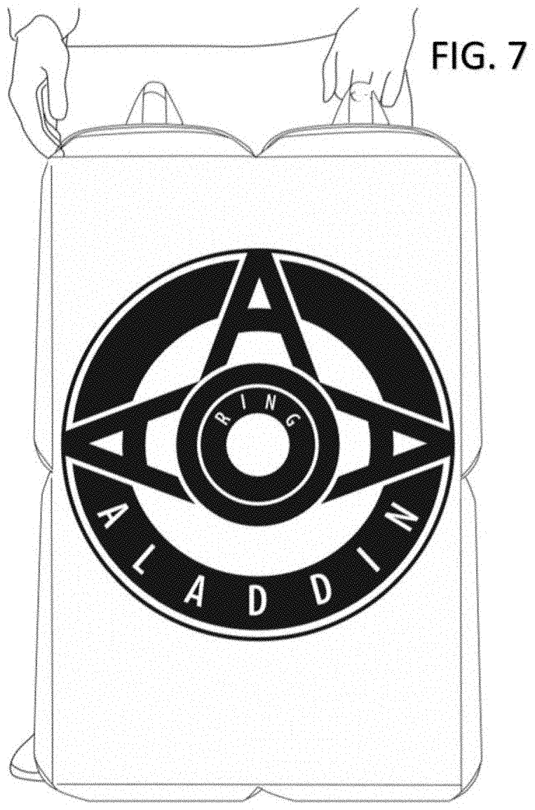

FIG. 7 illustrates an example of backpack 100, as shown, four modular units are connected with horizontal and vertical lock and clip displaying an Aladdin Ring emblem on display screen 102.

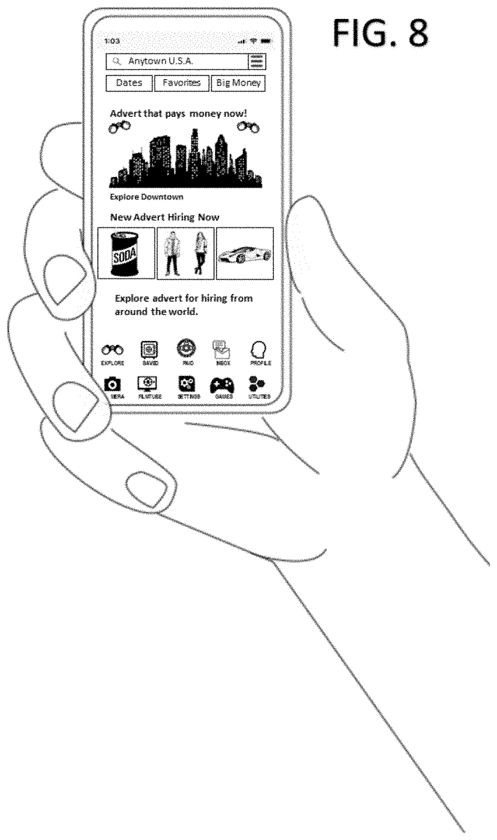

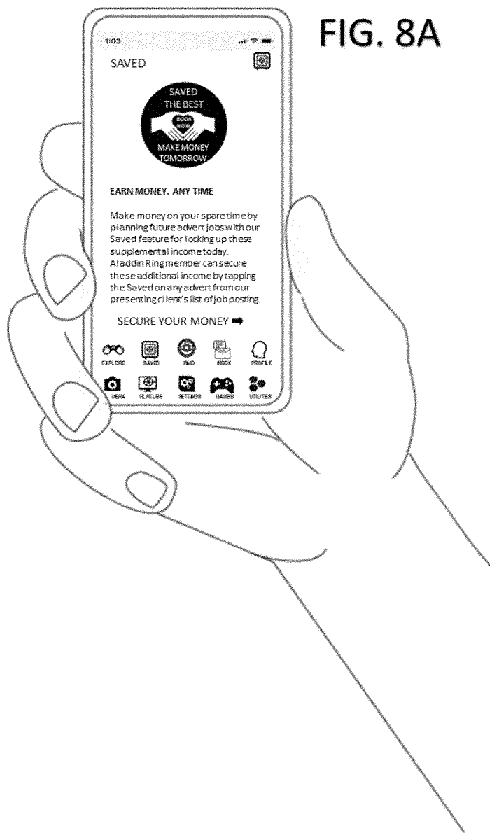

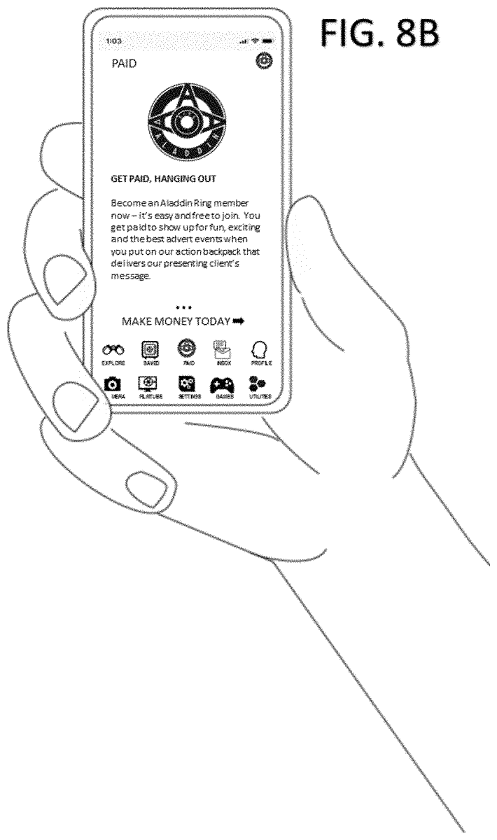

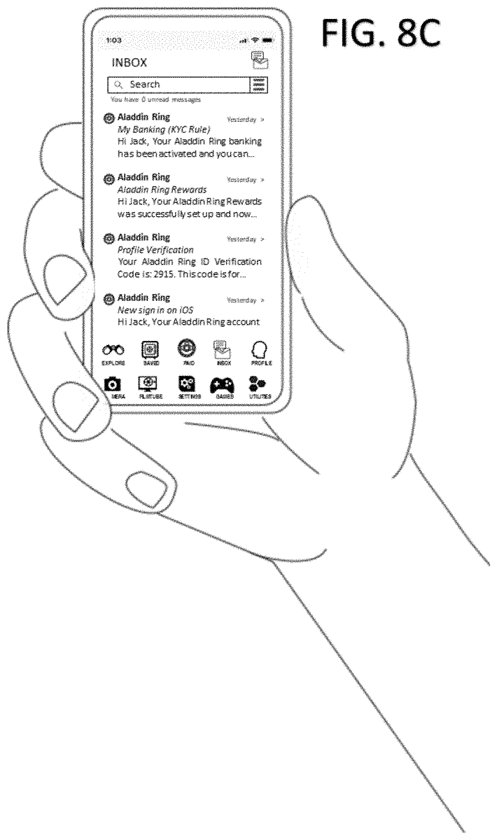

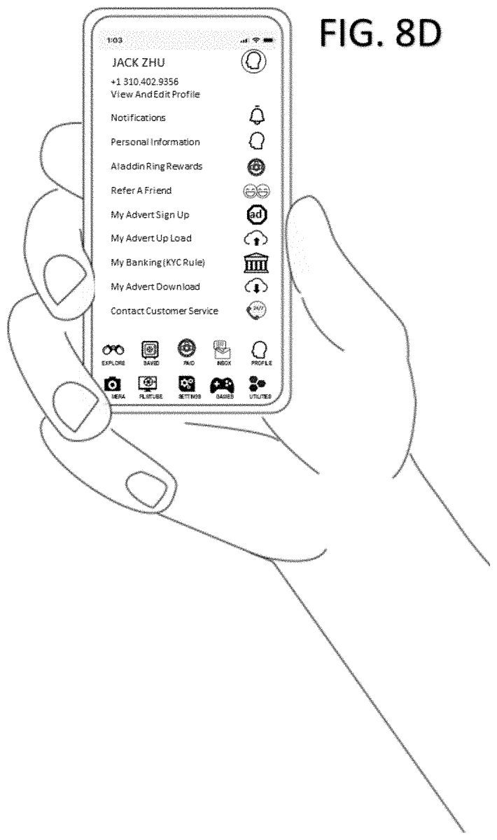

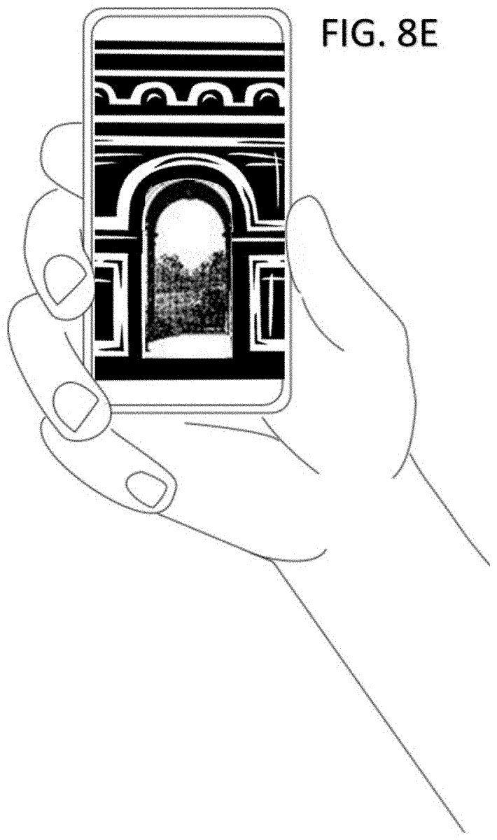

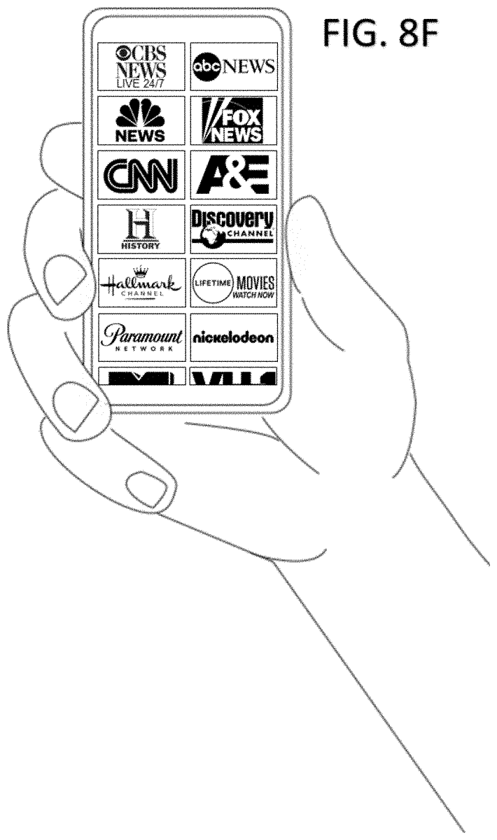

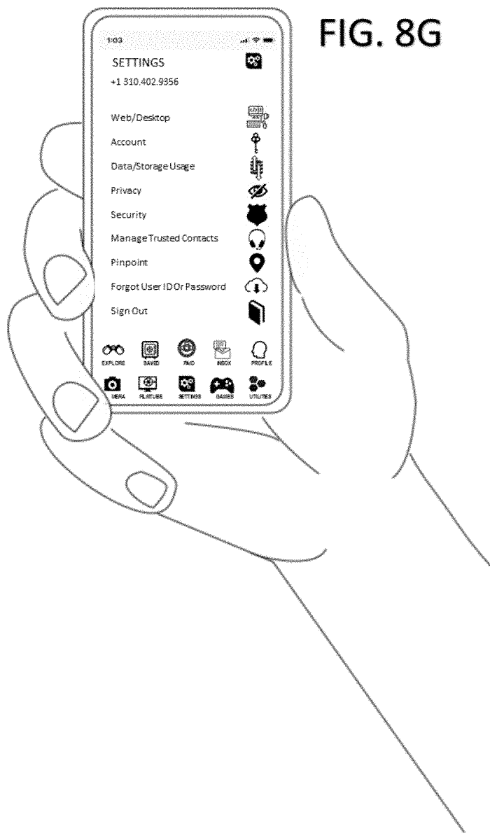

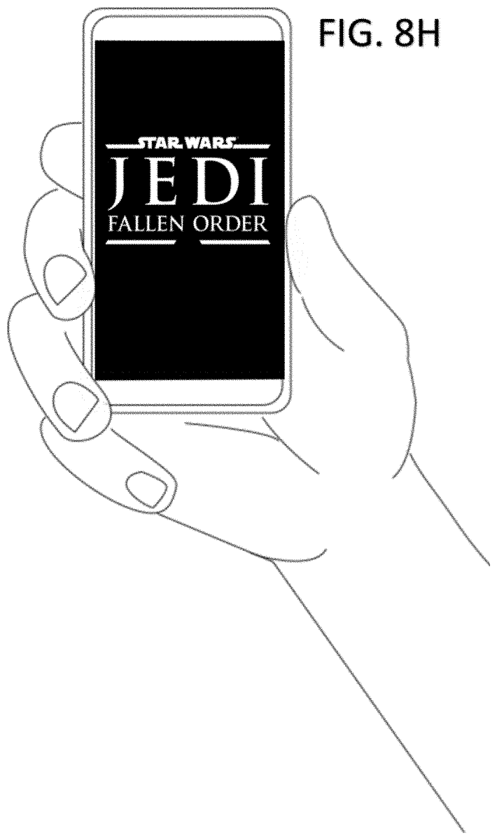

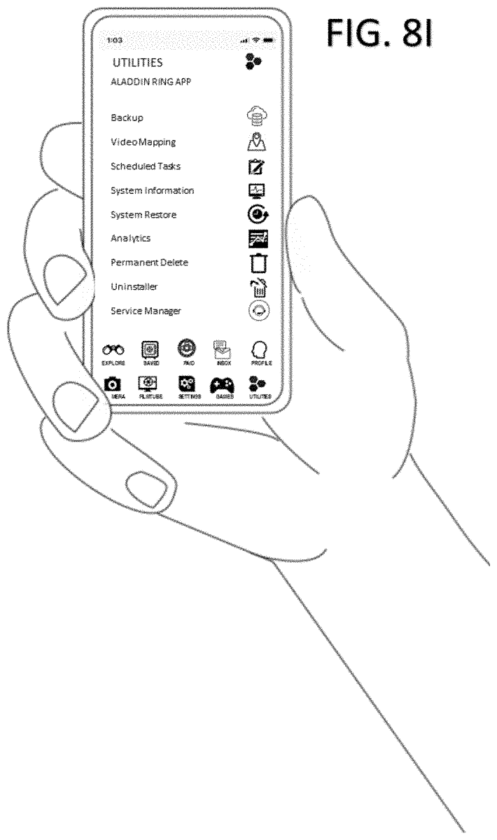

FIG. 8 illustrates an example of mobile device 118 displaying the “EXPLORE” feature of the mobile application, where the independent contract worker is a strategic targeted advertisement reconnaissance (STAR) searching for ad-for-hire jobs within his or her desire travel destination for working.

FIG. 8A illustrates an example of mobile device 118 displaying the “SAVED” feature of the mobile application, where the independent contract worker is a strategic targeted advertisement reconnaissance (STAR) that can accept an ad-for-hire job in advance and booked it with the advertiser for his or her next paying job.

FIG. 8B illustrates an example of mobile device 118 displaying the “SAVED” feature of the mobile application, where the independent contract worker is a strategic targeted advertisement reconnaissance (STAR) that may set-up an account with Aladdin Ring App banking with their personal banking account and receive money for ad-for-hire job, in addition, every STAR can send and receive money from each other within the same network, using automated clearing house (ACH) payment processing.

FIG. 8C illustrates an example of a mobile device 118 displaying the “INBOX” feature of the mobile application, where the independent contract worker is a strategic targeted advertisement reconnaissance (STAR) can send and receive messages with another STAR or within the same network.

FIG. 8D illustrates an example of a mobile device 118 displaying the “PROFILE” feature of the mobile application, where new members activate their backpack 100 with their remote control 118 using their phone number to create their account and with each activation within the App, additional features are available, including eligibility as an independent contract worker is a strategic targeted advertisement reconnaissance (STAR).

FIG. 8E illustrates an example of a mobile device 118 displaying the “CAMERA” feature of the mobile application, where a STAR may access their backpack 100 and take pictures or record and view it on their mobile device 118.

FIG. 8F illustrates an example of mobile device 118 displaying the “FILMTUBE” feature of the mobile application, where a STAR may access streaming video channels online for playing on their backpack 100.

FIG. 8G illustrates an example of mobile device 118 displaying the “SETTINGS” feature of the mobile application, where a STAR may access their account for modifying the internal setting of their Aladdin Ring App for adjustments.

FIG. 8H illustrates an example of remote-control 118 displaying the “GAMES” feature of the mobile application, where a STAR may access streaming video games online for playing on their backpack 100.

FIG. 8I illustrates an example of remote-control 118 displaying the “UTILITIES” feature of the mobile application, where a STAR may access their Aladdin Ring App for corrections to their software or allow Aladdin Ring tech department to correct any bugs with the App.

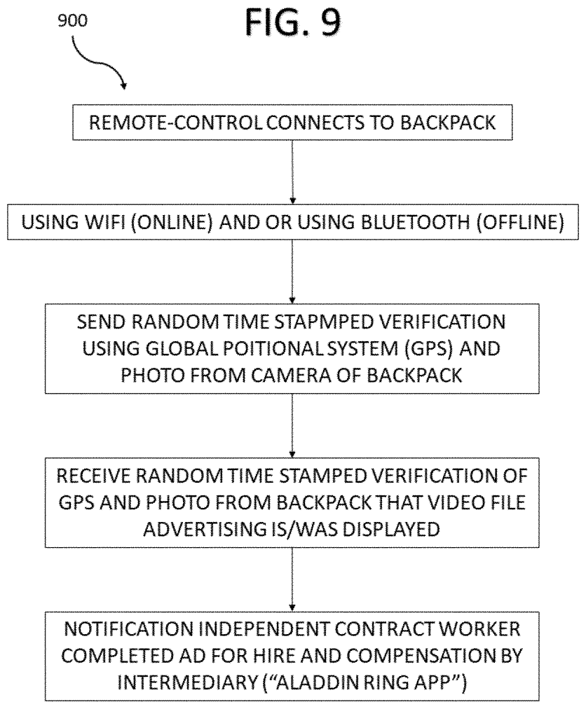

FIG. 9 illustrates an example method of interfacing between the mobile unit 118 and backpack 100.

FIG. 10 illustrates an example of a flexible MicroLED or MiniLED 1000, light weight, hollow design, can bend, wrap, drape, and fold to conform to even the most unusual shape and size providing various applications, such as, can be hung on the truss or supported structure, and can fold like clothes.

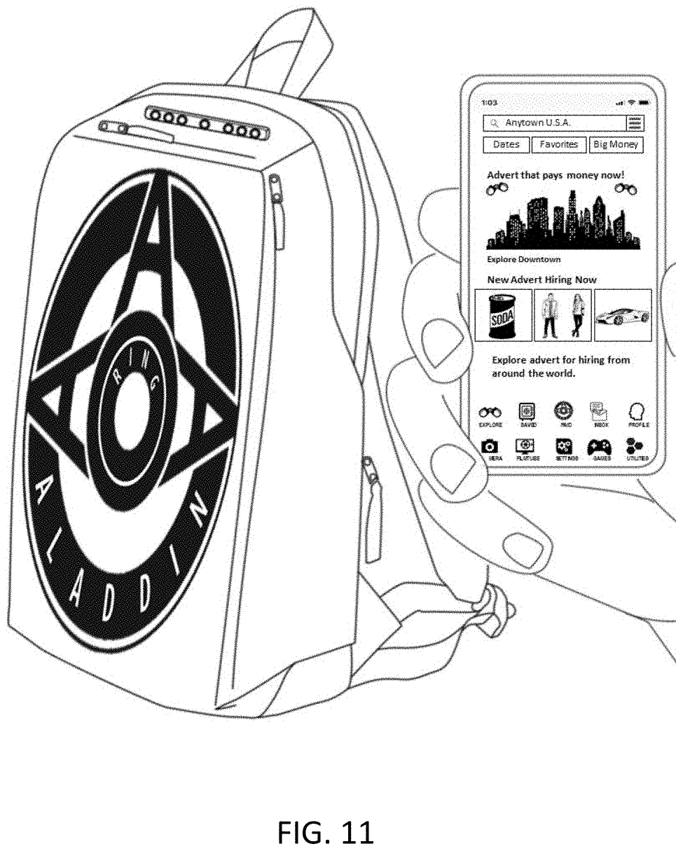

FIG. 11 illustrates an example of the backpack 100 and mobile device 118 incorporating the digital display apparatus of the present disclosure.

In general, terms such as “coupled to,” and “configured for coupling to,” and “secured to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

Although the previous description illustrates particular examples of various implementations, the present disclosure is not limited to the foregoing illustrative examples. A person skilled in the art is aware that the disclosure as defined by the appended claims and their equivalents can be applied in various further implementations and modifications. In particular, a combination of the various features of the described implementations is possible, as far as these features are not in contradiction with each other. Accordingly, the foregoing description of implementations has been presented for purposes of illustration and description. Modifications and variations are possible in light of the above description.

What is claimed is:

1. A backpack having an inward body side and an outward non-body side, where the body side and the non-body side define an interior compartment, the backpack comprising:
an active element coupled to an outer surface of the non-body side of the backpack, the active element comprising a digital display;
a removable power supply housed in the interior compartment of the backpack; and
a transmitter electrically coupled between the power supply and the active element;
wherein the transmitter is in wireless electrical communication with a remote central processing unit (CPU) for receiving and sending data files of content and images to be broadcast on the active element.

2. The backpack of claim 1, wherein the active element is a modular digital display that may be electronically coupled the active element of a complementary backpack to create a larger display screen.

3. The backpack of claim 1, wherein the active element is a digital screen display adapted to broadcast high-resolution video, text, images, an illumination color, and amination.

4. The backpack of claim 1, wherein the active element comprises a flexible display screen or panel structure display screen.

5. The backpack of claim 1, wherein the active element comprises a MicroLED or MiniLED display screen.

6. The backpack of claim 1, wherein the power supply and transmitter are housed within an interior compartment of the backpack.

7. The backpack of claim 1, wherein the power supply comprises with a charging port.

8. The backpack of claim 3, wherein the active element broadcasts high-resolution video, text, images, an illumination color, and amination from a USB and by wireless (streaming) communication.

9. The backpack of claim 1, wherein the active element acts as a user interface.

10. An advertising network comprising:
a digital marketplace for ads for hire, whereas, advertiser can post advertising jobs to a community board, each member that owns a backpack with display screen can explore territories they live, work or travel for accepting the advertising job;
a digital marketplace for searching ads for hire, whereas, a member can type in a destination or territories they live, work or travel will be compensated for completing an advertising task;
a wearable backpack with an active element that displays at least one of the advertising messages as a video file, a text, an image, an illumination color, and amination; and
a wearable backpack with an active element that can be connected with another active element in creating a larger digital screen for viewing advertisement.
